(19) United States
(12) Patent Application Publication
(10) Pub. No.: US 2025/0083975 A1
(43) Pub. Date: Mar. 13, 2025

(54) MEDIA MIXTURE FOR WATER TREATMENT

(71) Applicant: ADVANCED DRAINAGE SYSTEMS, INC., Hilliard, OH (US)

(72) Inventors: Bo Liu, Plain City, OH (US); Robin Joyce Maliszewskyj, Middletown, MD (US)

(73) Assignee: ADVANCED DRAINAGE SYSTEMS, INC., Hilliard, OH (US)

(21) Appl. No.: 18/827,151

(22) Filed: Sep. 6, 2024

Related U.S. Application Data
(60) Provisional application No. 63/537,450, filed on Sep. 8, 2023.

(51) Int. Cl. C02F 1/00

(52) U.S. Cl. CPC C02F 1/001; C02F 2305/00

(57) ABSTRACT

A media mixture for water treatment is provided. The media mixture may comprise activated alumina in an amount of from about 7% to about 17% by volume of the media mixture, activated carbon in an amount of from about 17% to about 42% by volume of the media mixture, and zeolite in an amount of from about 17% to about 57% by volume of the media mixture.

### CROSS REFERENCE TO RELATED APPLICATIONS

This application claims the benefit of priority of U.S. Provisional Application No. 63/537,450 filed on Sep. 8, 2023, the contents of which are incorporated herein by reference in their entirety.

### TECHNICAL FIELD

This disclosure relates generally to media mixtures for treating and filtering water, including methods of producing media mixtures and methods of using media mixtures for water treatment.

### BACKGROUND

Filtration media for the purpose of stormwater treatment have been in use for many years. Many filter media types utilize only one or two components, resulting in poor filtration performance and limited flow capacity. As a result, treatment for removing contaminants like dissolved phosphorus and heavy metals from water must be performed separately from sediment filtration. There is therefore a need for a water filtration media that provides both a high surface loading rate and simultaneous removal of contaminants and sediment.

### SUMMARY

Consistent with disclosed embodiments, systems, apparatuses, compositions, and methods related to media mixtures for water treatment are disclosed. According to an embodiment of the present disclosure, a media mixture for water treatment is provided. The media mixture includes activated alumina in an amount of from about 7% to about 17% by volume of the media mixture; activated carbon in an amount of from about 17% to about 42% by volume of the media mixture; and zeolite in an amount of from about 17% to about 57% by volume of the media mixture. In some embodiments, the media mixture additionally includes a filtration component in an amount of from about 0% to about 60% by volume of the media mixture. The filtration component includes at least one of lava rock, perlite, soil, or sand. In some embodiments, the amount of activated alumina is about 10% by volume of the media mixture. In some embodiments, the amount of activated carbon is about 20% by volume of the media mixture. In some embodiments, the amount of zeolite is about 40% by volume of the media mixture. In some embodiments, the amount of the filtration component is about 30% by volume of the media mixture.

According to embodiments of the present disclosure, methods of water treatment with a media mixture are provided. In some embodiments, methods of water treatment include placing the media mixture within a vessel; and directing water into the vessel such that the water flows through the media mixture, wherein the media mixture removes contaminants and sediment from the water. In alternative embodiments, methods of water treatment include placing the media mixture on or below a ground surface such that water runoff flows through the media mixture, wherein the media mixture removes contaminants and sediment from the water runoff.

According to embodiments of the present disclosure, a method of producing a media mixture for water treatment is provided. The method includes combining activated alumina, activated carbon, and zeolite to create the media mixture. In some embodiments, the method additionally includes adding a filtration component to the media mixture, the filtration component including at least one of lava rock, perlite, soil, or sand. In some embodiments, the method additionally includes adding water to the media mixture, wherein the water is added in an amount of from about 10% to about 20% by weight of the media mixture.

The forgoing summary provides certain examples of disclosed embodiments to provide a flavor for this disclosure and is not intended to summarize all aspects of the disclosed embodiments. Additional features and advantages of the disclosed embodiments will be set forth in part in the description that follows, and in part will be apparent from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments.

FIG. 1 is a front perspective view of a vessel containing a media mixture for water treatment.

FIG. 2 is a cross-sectional view of the vessel of FIG. 1, with the media mixture being used to treat and filter water.

### DETAILED DESCRIPTION

Examples of embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

As used herein, the phrases “for example,” “such as,” “for instance” and variants thereof describe non-limiting embodiments of the presently disclosed subject matter. Reference in the specification to features of “embodiments,” “examples,” “one case,” “some cases,” “other cases” or variants thereof means that a particular feature, structure or characteristic described may be included in at least one embodiment of the presently disclosed subject matter. Thus the appearance of such terms does not necessarily refer to the same embodiment(s). As used herein, the term “and/or” includes any and all combinations of one or more of the associated listed items. As used herein, the expression “at least one of . . . or” may include each listed item individually or any combination of the listed items. For example, the expression “at least one of A, B, or C” may include any of A, B, or C alone or any combination of A, B, and C (e.g., A+B, A+C, B+C, or A+B+C).

Features of the presently disclosed subject matter, are, for brevity, described in the context of particular embodiments. However, it is to be understood that features described in connection with one embodiment are also applicable to other embodiments. Likewise, features described in the context of a specific combination may be considered separate embodiments, either alone or in a context other than the specific combination.

Examples of the presently disclosed subject matter are not limited in application to the details of construction and the arrangement of the components set forth in the following description or illustrated in the drawings. The subject matter may be practiced or carried out in various ways. Also, it is to be understood that the phraseology and terminology employed herein is for the purpose of description and should not be regarded as limiting.

Consistent with disclosed embodiments, a media mixture is provided with multiple components in specified ratios. Key components of the media mixture are activated alumina, activated carbon, and zeolite. The media mixture is configured to be used for treating water (such as stormwater and runoff) by filtering out suspended sediment and removing contaminants such as phosphorus, copper, and zinc by adsorption. Specifically, the surface of the media mixture has ionic properties that allow it to chemically bind to the contaminants and correspondingly remove the contaminants from the water undergoing treatment. Advantageously, the media mixture provides a high surface loading rate (i.e., rate of flow of water through the media mixture), meaning that the water treatment occurs quickly and does not cause water to become backed up. The media mixture is also highly effective at removing contaminants from water, including phosphorus, copper, and zinc.

In some embodiments, the alumina and carbon may each be activated by a thermal or chemical process to enhance their respective adsorption capacity.

Optionally, one or more additional filtration components may be added to the media mixture to capture solids (e.g., sediment) suspended in the water and, in some cases, to “loosen” the media mixture for increased flow capacity. However, the filtration component is not essential for the media mixture's purpose of adsorbing contaminants. Some non-limiting examples of suitable filtration components include lava rock, perlite, sand, and soil. These materials are suitable to be used as the filtration component due to their particle size, porosity, and relatively low cost. The type and quantity of the filtration component may be determined based on a balance between the objectives of removing solids and maintaining high flow rate, as an increase in one generally results in a decrease in the other.

The constituent components of the media mixture are provided in specific relative amounts in order to achieve an optimum balance between high surface loading rate, high rates of contaminant removal, and minimized costs. These relative amounts were determined through experimental testing of mixtures with different relative amounts of the constituent components, with contaminant removal rates (specifically, copper, zinc, and phosphorous) and surface loading rate being measured for each mixture. Additional factors including cost, availability, and ease of blending were also considered in selecting the relative amounts of the constituent components. For example, due to the high cost of activated carbon, a high-performing mixture with a low amount of activated carbon may be preferable to another high-performing mixture with a higher amount of activated carbon.

In disclosed embodiments, the media mixture may include activated alumina in an amount of from about 7% to about 17% by volume, activated carbon in an amount of from about 17% to about 42% by volume, zeolite in an amount of from about 17% to about 57% by volume, and the filtration component in an amount of from about 0% to about 60% by volume. In a preferred embodiment, about 10% by volume of the media mixture may be activated alumina, about 20% by volume may be activated carbon, about 40% by volume may be zeolite, and about 30% by volume may be the filtration component. These relative amounts are shown in Table 1:

TABLE 1

| | Minimum % | Maximum % | Preferred % |
|---|---|---|---|
| Component | by Volume | by Volume | by Volume |
| Activated alumina | 7 | 17 | 10 |
| Activated carbon | 17 | 42 | 20 |
| Zeolite | 17 | 57 | 40 |
| Filtration component | 0 | 60 | 30 |
| (lava rock / perlite / | | | |
| soil / sand) | | | |

The media mixture may be used to filter and treat water or other fluids in a variety of applications. The fluid to be treated may include, e.g., stormwater, runoff, water from a body (e.g., a pond or river), or waste water. As a non-limiting example, the media mixture may be placed within a vessel or container, and water may be directed to flow through the vessel (and thus, through the media mixture). As the water flows through it, the media mixture removes contaminants and suspended materials (e.g., sediment) from the water. Additionally, or alternatively, the media mixture may be placed on or below the ground surface (e.g., in a hole in the ground) such that water runoff flows through the media mixture. As this occurs, the media mixture removes contaminants and sediment from the water runoff.

Some non-limiting examples of devices and structures that may be used with the media mixture for water treatment and/or filtration include green infrastructure manufactured treatment devices, stormwater storage chambers, hydrodynamic separators, bioreactors, a bioswale, a bioretention pond, a raingarden or similar type of system, and a filtration device or mechanism (such as membrane, screen, fabric, cartridge, or pillow bag).

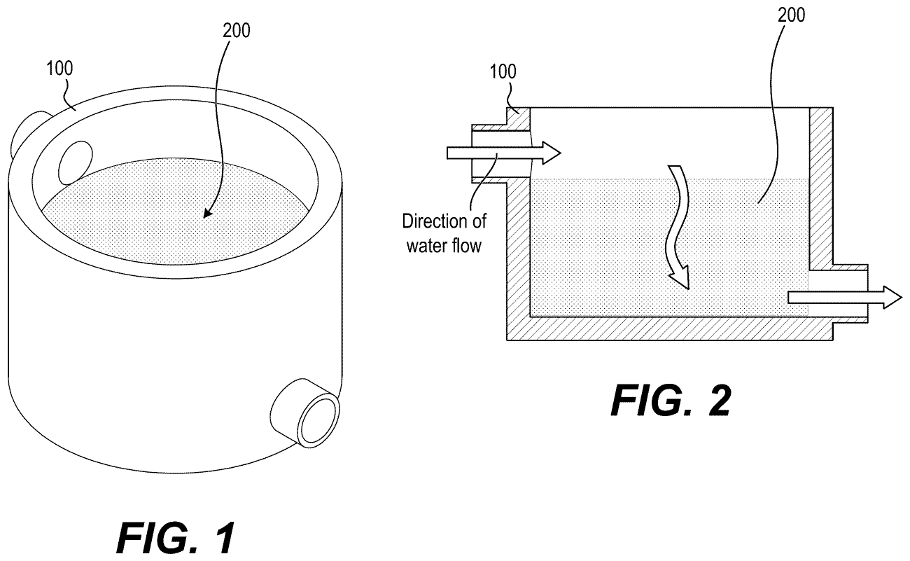

FIGS. 1 and 2 illustrate a non-limiting example of the media mixture 200 being used with a filtration device 100 to treat and filter water. Media mixture 200 may be placed within the filtration device 100, and water may then be introduced into the filtration device 100 so that it is filtered through the media mixture 200. The treated water may then exit the filtration device 100 and may, for example, be conveyed to another container for storage, collected by a drain or collection device, or allowed to be absorbed by the surrounding earth.

In disclosed embodiments, the media mixture may be formed by combining the ingredients in a mechanical mixer. In some instances, the filtration component (e.g., perlite) is added last due to its relative fragility. Optionally, blending of the media mixture may be simplified by adding water (from about 10% to about 20% by weight of the (dry) media mixture) to the combined components and blending the resultant mixture.

### Example 1

A test was conducted to evaluate the contaminant removal rates and the surface loading rate of the media mixture having the constituent component amounts discussed above. The test included seven (7) trials in which the media mixture was placed in a vessel and water dosed with a known amount of contaminants was introduced into the system at a known flow rate and allowed to flow through the media mixture. Trial 1 was performed with a commercial-scale prototype unit, while trials 2-7 were performed using a small amount of the media mixture in a bench-scale-sized vertical column.

The amounts of activated alumina, activated carbon, zeolite, and filtration component included in the media mixture for each trial are listed below in Table 2, in the column labelled “Component Percentage by Volume.” For each trial, the amount of each constituent component was within the range of acceptable values discussed above. For example, the amount of activated alumina was 7% by volume in trial 1 and 10% by volume in trials 2-7. These two values (7% and 10%) are both within the “about 7% to about 17% by volume of the media mixture” range discussed above. Notably, all seven trials were conducted with a media mixture containing a filtration component. However, the corresponding amounts of activated alumina, activated carbon, and zeolite without the filtration component were also calculated for each trial and are listed in Table 2 in the column labelled “Equivalent Component Percentage Without Filtration Comp. D.”

Samples of the effluent from each trial were collected and analyzed to determine the remaining concentrations of the contaminants, and removal efficiency percentages were calculated for each trial. The contaminants removed and tested for were copper, zinc, and phosphorous. The results of each trial are summarized below in Table 2.

TABLE 2

| | | | | | Equivalent Component | | | | | | | |
|---|---|---|---|---|---|---|---|---|---|---|---|---|
| | Component Percentage | | | | Percentage Without | | | | | | | |
| | by Volume | | | | Filtration Comp. D | | | | Flow Rate | % Cu | % Zn | % Phos |
| Trial # | A | B | C | D | A | B | C | D | (gpm/ft\hat{ }2) | Removal | Removal | Removal |
| 1 | 7 | 16.5 | 16.5 | 60 | 17 | 41.5 | 41.5 | 0 | 4 | 89 | 88 | 71 |
| 2 | 10 | 20 | 35 | 35 | 15 | 31 | 54 | 0 | 4.2 | 82 | 62 | 54 |
| 3 | 10 | 20 | 40 | 30 | 14 | 29 | 57 | 0 | 3.7 | 83 | 63 | 85 |
| 4 | 10 | 20 | 40 | 30 | 14 | 29 | 57 | 0 | 3.7 | 86 | 69 | 84 |
| 5 | 10 | 20 | 40 | 30 | 14 | 29 | 57 | 0 | 3.7 | 85 | 73 | 75 |
| 6 | 10 | 20 | 40 | 30 | 14 | 29 | 57 | 0 | 3.7 | 88 | 89 | 85 |
| 7 | 10 | 20 | 40 | 30 | 14 | 29 | 57 | 0 | 3.7 | 84 | 71 | 79 |

| Comp | | Min % | Max % |
|---|---|---|---|
| ID | Component | by Vol | by Vol |
| A | Activated Alumina | 7 | 17 |
| B | Activated Carbon | 17 | 42 |
| C | Zeolite | 17 | 57 |
| D | Lava Rock/Perlite/Soil/Sand | 0 | 60 |

As shown in Table 2, the media mixture achieved both a high flow rate (3.7-4.2 gpm/ft²) and high removal rates of copper, zinc, and phosphorous in all seven trials. Unlike prior water treatment media, which provide either high flow rates or high contaminant removal rates but not both, the media mixture of the present disclosure provided both high flow rates and high contaminant removal rates.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments.

As used in the present disclosure, the terms “around”, “about,” and “approximately” shall generally mean within the error margin generally accepted in the art. Hence, numerical quantities claimed and disclosed herein generally include such error margin such that the terms “around”, “about,” and “approximately” can be inferred if not expressly stated. For example, the quantity “about 17%” means any value in the internal of 17%+/− the generally accepted error margin in the art (as a percentage), including the outpost values.

Although this disclosure has been shown and described with respect to the detailed embodiments thereof, it will be understood by those of skill in the art that various changes may be made and that equivalents, modifications, omissions, combinations (e.g., of aspects across various embodiments), adaptations and/or alterations may be added to and/or substituted for elements thereof without departing from the scope of the disclosure. The elements in the claims are to be interpreted broadly based on the language employed in the claims and not limited to examples described in the present specification or during the prosecution of the application, which examples are to be construed as nonexclusive. In addition, modifications may be made to adapt a particular situation or material to the teachings of the disclosure without departing from the essential scope thereof. Further, the steps of the disclosed methods can be modified in any manner, including reordering steps and/or inserting or deleting steps. Therefore, it is intended that the scope of the appended claims not be limited to the particular embodiments disclosed in the above detailed description, but that the scope of the appended claims will include all embodiments falling within the scope of this disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A media mixture for water treatment, the media mixture comprising:
activated alumina in an amount of from about 7% to about 17% by volume of the media mixture;
activated carbon in an amount of from about 17% to about 42% by volume of the media mixture; and
zeolite in an amount of from about 17% to about 57% by volume of the media mixture.

2. The media mixture of claim 1, further comprising:
a filtration component in an amount of from about 0% to about 60% by volume of the media mixture.

3. The media mixture of claim 2, wherein the filtration component comprises at least one of lava rock, perlite, soil, or sand.

4. The media mixture of claim 1, wherein:
the amount of activated alumina is about 10% by volume of the media mixture;
the amount of activated carbon is about 20% by volume of the media mixture; and
the amount of zeolite is about 40% by volume of the media mixture.

5. The media mixture of claim 2, wherein:
the amount of activated alumina is about 10% by volume of the media mixture;
the amount of activated carbon is about 20% by volume of the media mixture;
the amount of zeolite is about 40% by volume of the media mixture; and
the amount of the filtration component is about 30% by volume of the media mixture.

6. A media mixture for water treatment, the media mixture consisting of:
activated alumina in an amount of from about 7% to about 17% by volume of the media mixture;
activated carbon in an amount of from about 17% to about 42% by volume of the media mixture;
zeolite in an amount of from about 17% to about 57% by volume of the media mixture; and
a filtration component in an amount of from about 0% to about 60% by volume of the media mixture.

7. The media mixture of claim 6, wherein the filtration component comprises at least one of lava rock, perlite, soil, or sand.

8. The media mixture of claim 6, wherein:
the amount of activated alumina is about 10% by volume of the media mixture;
the amount of activated carbon is about 20% by volume of the media mixture;
the amount of zeolite is about 40% by volume of the media mixture; and
the amount of the filtration component is about 30% by volume of the media mixture.

9. The media mixture of claim 1, wherein the media mixture is configured to remove one or more of copper, zinc, or phosphorous from a flow of water.

10. The media mixture of claim 1, wherein the media mixture is configured to be placed in a vessel to remove contaminants from a flow of water through the vessel.

11. A method of producing a media mixture for water treatment, the method comprising:
combining activated alumina, activated carbon, and zeolite to create the media mixture.

12. The method of producing a media mixture of claim 11, further comprising:
adding a filtration component to the media mixture, the filtration component including at least one of lava rock, perlite, soil, or sand.

13. The method of producing a media mixture of claim 12, wherein the filtration component is added to the media mixture after the activated alumina, activated carbon, and zeolite are added to the media mixture.

14. The method of producing a media mixture of claim 11, further comprising:
adding water to the media mixture, wherein the water is added in an amount of from about 10% to about 20% by weight of the media mixture.

15. The method of producing a media mixture of claim 11, wherein the activated alumina, activated carbon, and zeolite are combined in a mechanical mixer.

16. The method of producing a media mixture of claim 11, wherein the media mixture comprises:
the activated alumina in an amount of from about 7% to about 17% by volume of the media mixture;
the activated carbon in an amount of from about 17% to about 42% by volume of the media mixture; and
the zeolite in an amount of from about 17% to about 57% by volume of the media mixture.

17. The method of producing a media mixture of claim 12, wherein the media mixture comprises:
the activated alumina in an amount of from about 7% to about 17% by volume of the media mixture;
the activated carbon in an amount of from about 17% to about 42% by volume of the media mixture;
the zeolite in an amount of from about 17% to about 57% by volume of the media mixture; and
a filtration component in an amount of from about 0% to about 60% by volume of the media mixture.

18. The method of producing a media mixture of claim 17, wherein the media mixture comprises:
the activated alumina in an amount of about 10% by volume of the media mixture;
the activated carbon in an amount of about 20% by volume of the media mixture;
the zeolite in an amount of about 40% by volume of the media mixture; and
the filtration component in an amount of about 30% by volume of the media mixture.

19. The method of producing a media mixture of claim 9, wherein the media mixture is combined in a mechanical mixer.

20. The method of producing a media mixture of claim 9, wherein the activated alumina and the activated carbon are activated by a thermal process or a chemical process.
